(19) United States
(12) Patent Application Publication
(10) Pub. No.: US 2009/0035574 A1
(43) Pub. Date: Feb. 5, 2009

(54) Fiber Coating System

(76) Inventors: Peter Gable, Middlefield, CT (US); Richard Lint, Wallingford, CT (US); Gerald Blodgett, Wallingford, CT (US)

Correspondence Address: BOND, SCHOENECK & KING, PLLC, ONE LINCOLN CENTER, SYRACUSE, NY, 13202-1355, US

(21) Appl. No.: 11/831,059

(22) Filed: Jul. 31, 2007

(51) Int. Cl. B32B 9/00; G05B 15/00

(52) U.S. Cl. 428/391; 428/364; 700/275

(57) ABSTRACT

A system for coating fibers having a plurality of inlet conduits configured to receive a corresponding fiber; a reservoir for holding a coating solution to be applied to fibers passing through the reservoir; a dryer for drying coated fibers exiting the reservoir; a plurality of outlet conduits configured to receive a corresponding fiber; a winding assembly for individually winding fibers exiting from the plurality of outlet conduits; a sensing device for monitoring fiber conditions including fiber speed and fiber breakage; and a control unit operatively associated with the sensing device, winding assembly and dryer.

### TECHNICAL FIELD

The present invention relates generally to a coating system and more specifically to a system for coating fibers for use in dental restorative materials.

### BACKGROUND OF THE INVENTION

In the fabrication of fiber-reinforced composite restorative materials comprising fibers impregnated in a resin, it is important that the fibers adhere strongly to the resin and that no debonding occurs. In order to assist in the bonding of the fibers to the resin, the fibers may further be treated, for example, chemically or mechanically etched, silanized, or otherwise treated such as by grafting functional monomers to obtain proper coupling between the fibers and the resin matrix. Silanization renders the fibers hydrophobic, reducing the water sorption and improving the hydrolytic stability of the composite material, renders the fibers organophilic, improving wetting and mixing, and bonds the fibers to the polymeric matrix.

Current systems for coating fibers with materials such as silanes have many limitations. The processes are limited as to the number of fibers that may be put through the system, typically, not greater than two fibers at a time. Current devices do not have the ability to adjust and monitor the line tension during the process nor do they monitor line breakage. It is difficult to maintain proper fiber alignment throughout the process.

It would be advantageous to provide a system that automates the fiber coating process. It would be beneficial to provide a system that monitors the fiber coating process for line breakage, tension and other factors automatically.

### SUMMARY OF THE INVENTION

These and other objects and advantages are accomplished by the coating system of the present invention that provides an automated process for coating fibers with a coupling or other material. The coating system includes a plurality of inlet conduits positioned downstream from a source of fibers, each inlet conduit configured to receive a corresponding fiber; a reservoir positioned downstream from the inlet conduits for holding a coating solution to be applied to fibers passing through the reservoir from the inlet conduits; a dryer positioned downstream from the reservoir for drying coated fibers exiting the reservoir; a plurality of outlet conduits positioned downstream from the dryer, each outlet conduit configured to receive a corresponding fiber; a winding assembly positioned downstream from the outlet conduits for individually winding fibers exiting from the plurality of outlet conduits; a sensing device disposed between the source of fibers and the winding assembly for monitoring fiber conditions including fiber speed and fiber breakage; and a control unit operatively associated with the sensing device, winding assembly and dryer.

The system may further include a computer or programmable logic controller to start and stop the operation of the system and for providing a read-out of the device parameters. The winding assembly includes a plurality of finishing spools for winding the fibers thereon and a plurality of winder guides for guiding the fibers to the finishing spools.

The system may further include a series of spools positioned downstream from the outlet conduits, whereby the outlet conduits are shortened and the spools are inserted to guide the fibers to the winding assembly.

In a process for coating fibers provided herein, a plurality of fibers are guided through a plurality of inlet conduits and passed through a reservoir having a coating solution therein, whereby the fibers are coated with a coating solution. Thereafter, the coated fibers are sent through a dryer whereby the coating solution is activated and the solvents are dried and subsequently passed through a plurality of outlet conduits for directing the fibers onto loading spools, upon which the fibers are wrapped. Alternatively, the outlet conduits may be shortened and a set of guiding spools may be used to guide the fibers onto loading spools of the winding assembly.

### BRIEF DESCRIPTION OF THE DRAWING

For the purpose of illustrating the invention, there are shown in the drawings, features which are presently preferred; it being understood, however that this invention is not limited to the precise arrangements and instrumentalities shown. Referring now to the drawings wherein like elements are numbered alike in the several Figures:

FIG. 1 is a perspective view of the fiber coating system of the present invention;

FIG. 2 is an enlarged view of the fibers being pulled onto a reel;

FIG. 3 is an enlarged view of sensors used in the fiber coating system;

FIG. 4 is a perspective view of the fibers being pulled through the system;

FIG. 5 is an enlarged view of a programmable logic controller used in the system;

FIG. 6 is top plan view of a coating bath used in the system;

FIG. 7 is a perspective view of the containment vessel containing the coating solution being pumped into the system;

FIG. 8 is an enlarged view of the heating unit used in the process;

FIG. 9 is an enlarged view of the exiting of the fibers in the process;

FIG. 10 is an enlarged view of the fibers being wound on spools;

FIG. 11 is an enlarged view of the fibers being wound on spools;

FIG. 12 is an enlarged view of the fibers being wound on spools;

FIG. 13 is an enlarged view of the incoming fibers on a spool;

FIG. 14 is an enlarged view of the incoming fibers on a spool;

FIG. 15 is an enlarged view of incoming fibers on a group of spools;

FIG. 16 is an enlarged view of fibers exiting the heater in the process; and

FIG. 17 is an enlarged view of the fibers exiting the heater in the process.

### DETAILED DESCRIPTION OF THE INVENTION

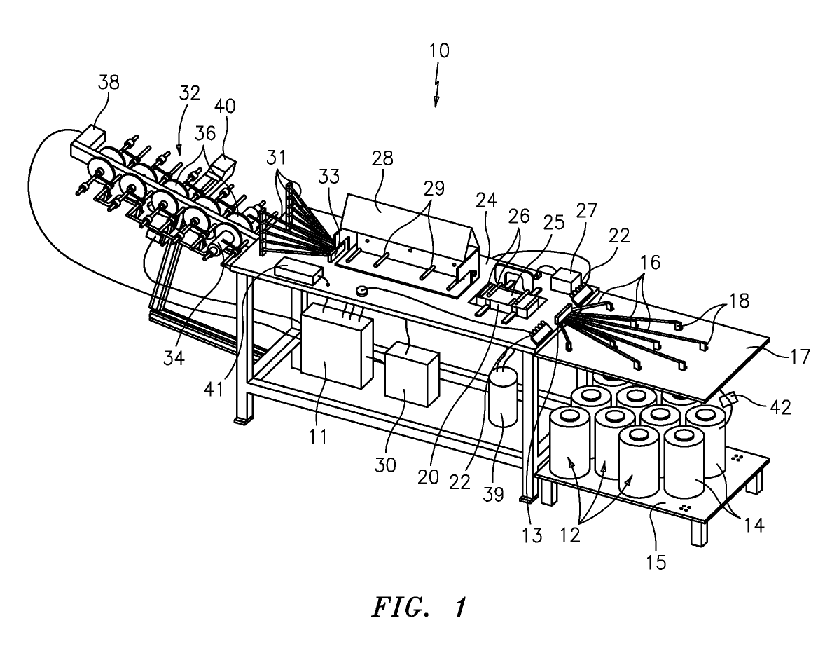

The present invention is directed to a system for coating fibers. The system automates the fiber coating process, providing a faster, more efficient method of coating a high number of fibers. Reference is made to FIG. 1, which shows a system 10 for coating fibers. A series of starting spools 12 having fibers 14 thereon are positioned on a table 15 proximate system 10. System 10 shows ten spools 12, although more or less may be used depending on the production needs and demands. Fibers 14 may be any fiber known in the art, including, but not limited to, glass, carbon, graphite, polyaramid, or other fibers known in the art, such as polyesters, polyamides, and other natural and synthetic materials compatible with the polymeric matrix. Other examples of fibrous materials are disclosed in U.S. Pat. Nos. 4,717,341 and 4,894,012 and commonly assigned U.S. Pat. Nos. 6,039,569, 6,013,694, all which are incorporated herein by reference. The fibers may be provided as single strands, bundles of fibers or other forms known in the art.

A main control unit 11 controls the operation of system 10 including the speed at which the fibers are pulled through the operation. Control unit 11 is programmed to provide instructions to the units in system 10. Control unit 11 can be programmed by a computer. The fibers may be pulled through the operation at a speed in the range of from about 20 to about 100 inches/minute, and preferably at a speed in the range of from about 40 to about 60 inches/per minute.

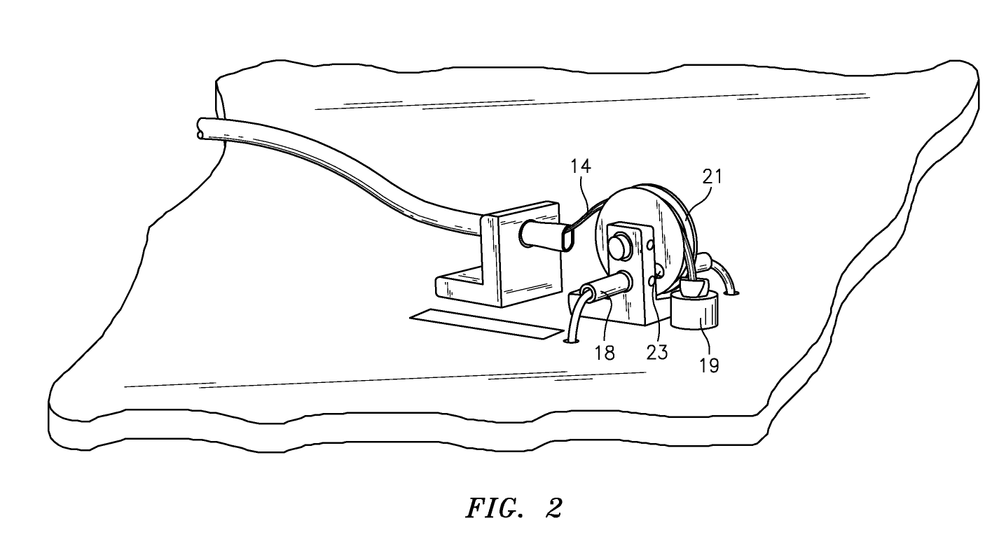

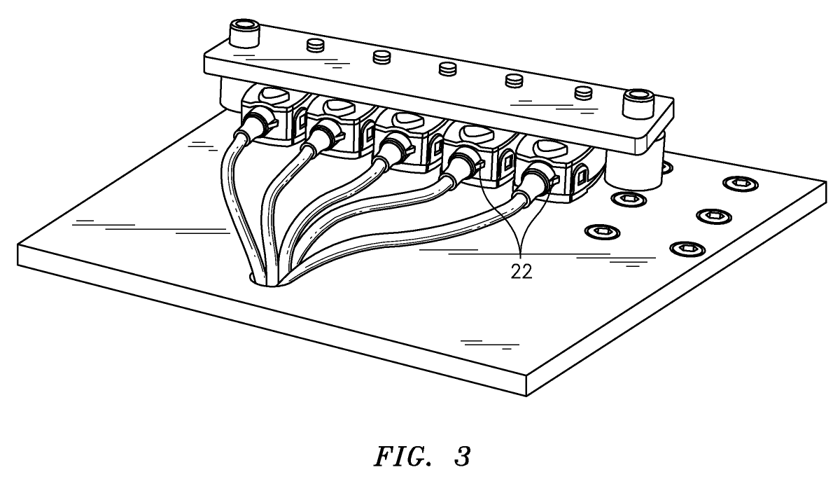

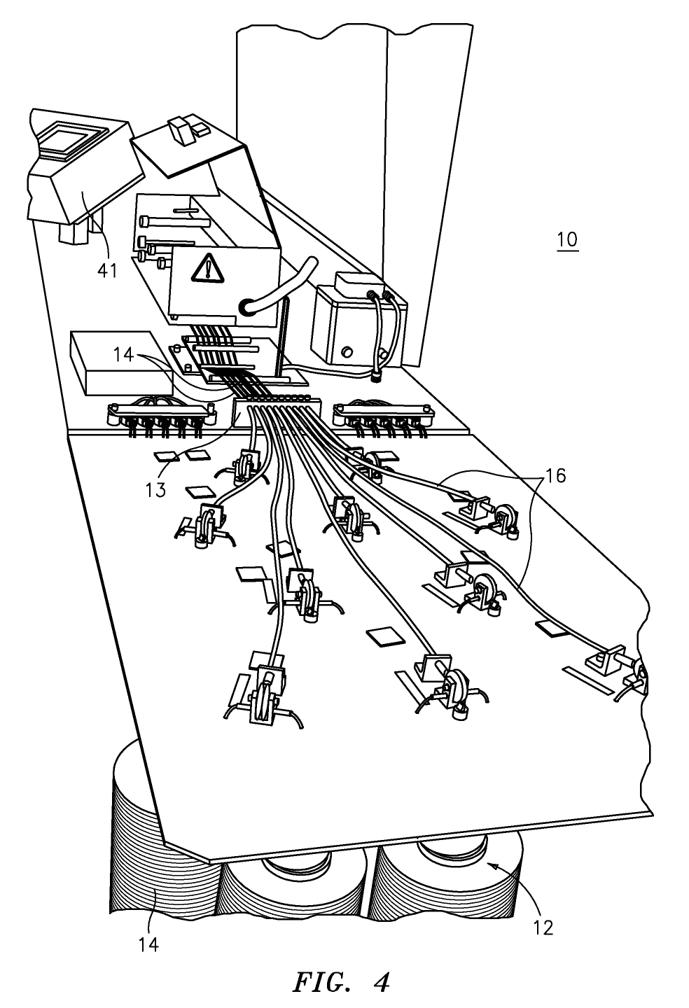

A plurality of conduits 16 extend from a plate or table 17 and are used to guide fibers 14 into a reservoir 20. Conduits 16 may be of any known material such as stainless steel. A bracket 13 may be used to align conduits 16 in the proper direction of the operation. Sensors 18 are disposed proximate conduits 16 and detect the presence of fibers 14. FIG. 2 shows a more comprehensive view of sensors 18. Each fiber may be monitored by a sensor 18. Sensors 18 can detect movement of fibers 14 and also can detect the speed of the fibers traveling through the system. Sensors 18 may be any type known in the art, including, but not limited to, a proximity switch, a limit switch, a hall-effect switch, an electro-mechanical switch, a motion switch, a magnetic sensor, a thermocouple sensor or an optical sensor. Fibers 14 are pulled through an opening 19 in table 17 and guided onto a bobbin or reel 21. (See FIG. 2). One way of monitoring the movement and speed of fibers 14 is to monitor the movement of bobbin 21. As fibers 14 are pulled through the system pathway, bobbins 21 are rotated. Bobbins 21 may include an opening 23 therein. As bobbin 21 rotates, opening 23 passes through sensor 18 at each rotation. As a result, sensor 18 can sense movement of bobbin 21. Should a fiber break, bobbin 21 stops rotating and sensor 18 detects the absence of movement of bobbin 21. Alternatively, should the speed of the fiber increase or decrease, sensor 18 shall detect such change in speed. Sensor 18 sends a signal to control unit 11 via a sensor 22. It is preferable that sensor 18 is a mechanical sensor that senses the movement of bobbin 21 and that sensor 22 is an electronic sensor such as an LED photo light admitting diode sensor. FIG. 3 show sensor 22. Control unit 11 will respond to the signal by shutting down the operation of system 10, or altering the speed of the fibers, respectively. FIG. 4 shows fibers 14 being pulled through system 10.

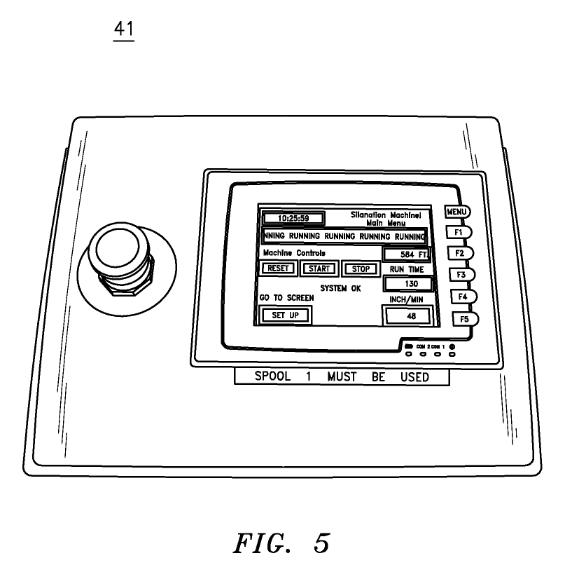

A programmable logic controller or PLC 41, is used to start and stop the operation. PLC 41 provides output for the speed of the fibers and the number of feet wrapped around spools 34 located at the end of the operation. PLC 41 is connected to control unit 11. FIG. 5 shows a more comprehensive view of PLC 41.

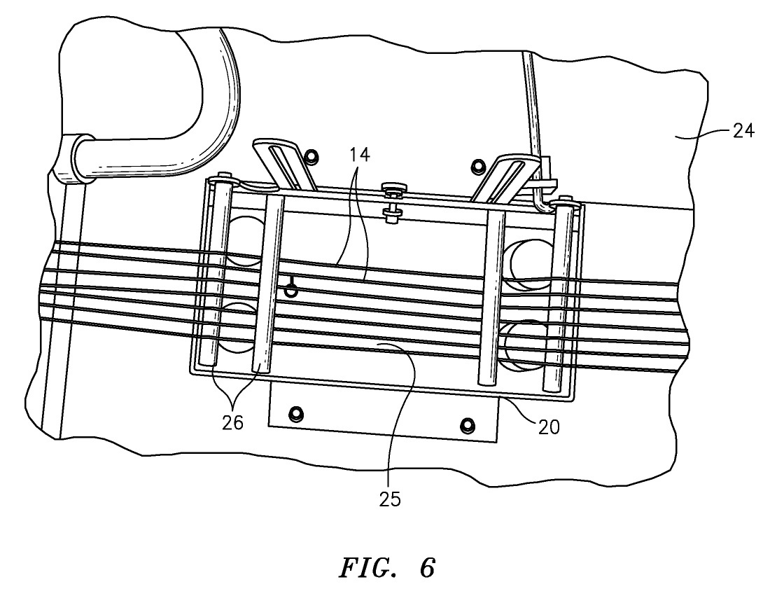

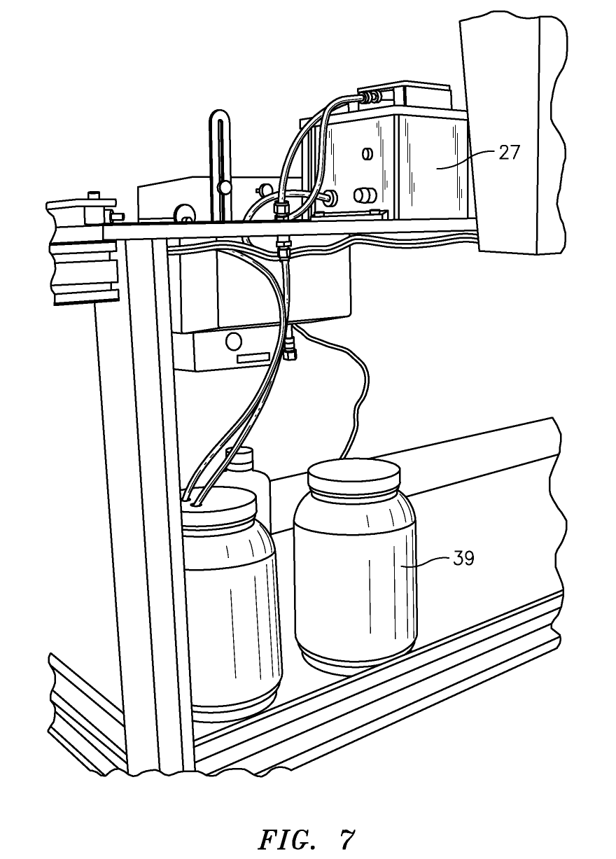

Coating bath or reservoir 20 is recessed in table 24 and retains a coating solution 25 for coating fibers 14. By positioning reservoir 20 into table 24, the fibers 14 maintain alignment more easily. FIG. 6 shows a more comprehensive view of reservoir 20. FIG. 7 shows containment vessel 39, which contains coating solution 25, which is pumped into reservoir 20 by pump 27. Pump 27 may be a peristaltic pump that continuously re-circulates the coating solution from reservoir 20 to containment vessel 39. Reservoir 20 includes a series of tension bars or rods 26 positioned strategically in reservoir 20 for maintaining fibers 14 in tension and for immersing fibers 14 into the coating solution 25. Bars 26 may be positioned strategically at any point to obtain immersion and tension of the fibers. Bars 26 aid in improving penetration and adhesion of the coating solution by spreading and opening the fiber bundles, exposing the filaments to the solution.

Coating solution 25 may be any solution known in the art, including, but not limited to, coupling solutions such as, silanes, titanates, zirconates, aluminates, etc. It is preferable that the coating solution is a silane solution such as gamma-methacryloxypropyltrimethoxysilane, or commercially available A-174 (p-methacrylate propyl tri-methoxy silane), produced by OSI Specialties, N.Y. Silane treatment improves resin wetting of the fibers to increase adhesion of resins to the fibers.

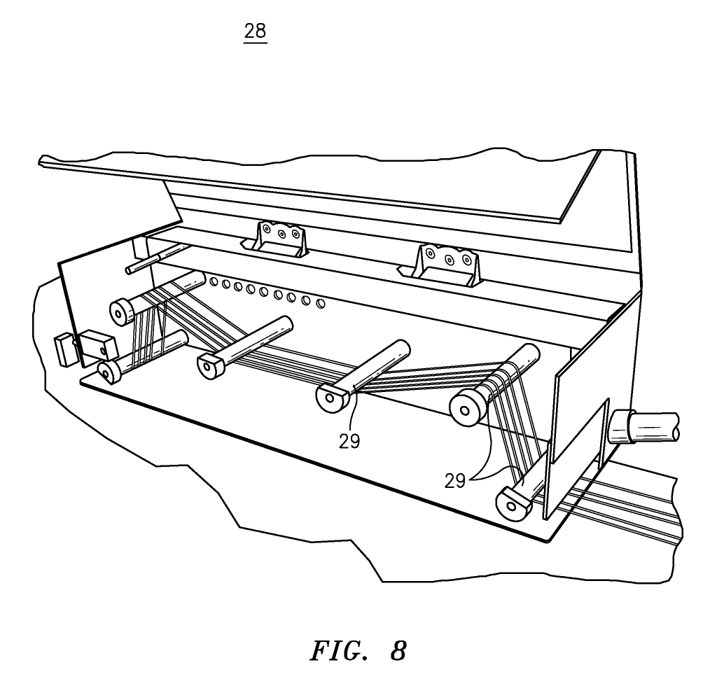

Adjacent reservoir 20 is a heating unit 28 for drying the coating solution 25 on fibers 14. Fibers 14 are dried at a temperature in the range of about 100 to about 200° F., depending on the coating solution applied thereto. If a silane solution is used, the temperature of the drying unit is preferably in the range of about 120 to 170° F., and more preferably, 140 to 160° F. Heating unit 28 contains a series of tension bars 29 for maintaining fibers 14 in tension and for increasing the amount of time that fibers 14 may be exposed to heat. Tension bars 26 in reservoir 20 and tension bars 29 in heating unit 28 may contain grooves therein to assist in the alignment of fibers 14. A temperature control unit 30 controls the temperature in heating unit 28. One example of a source of heat is a digital fan that generates an air current directed over heating elements. A thermostat monitors and maintains the temperature within a few degrees Fahrenheit. FIG. 8 shows a more comprehensive view of heating unit 28.

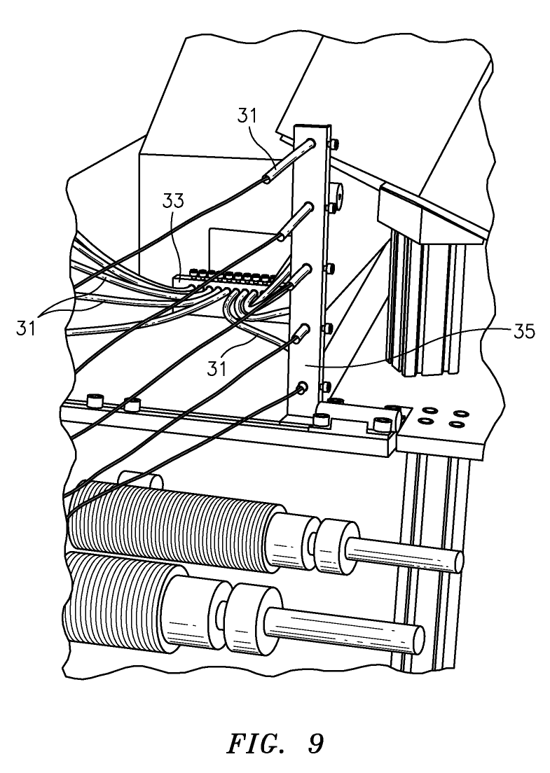

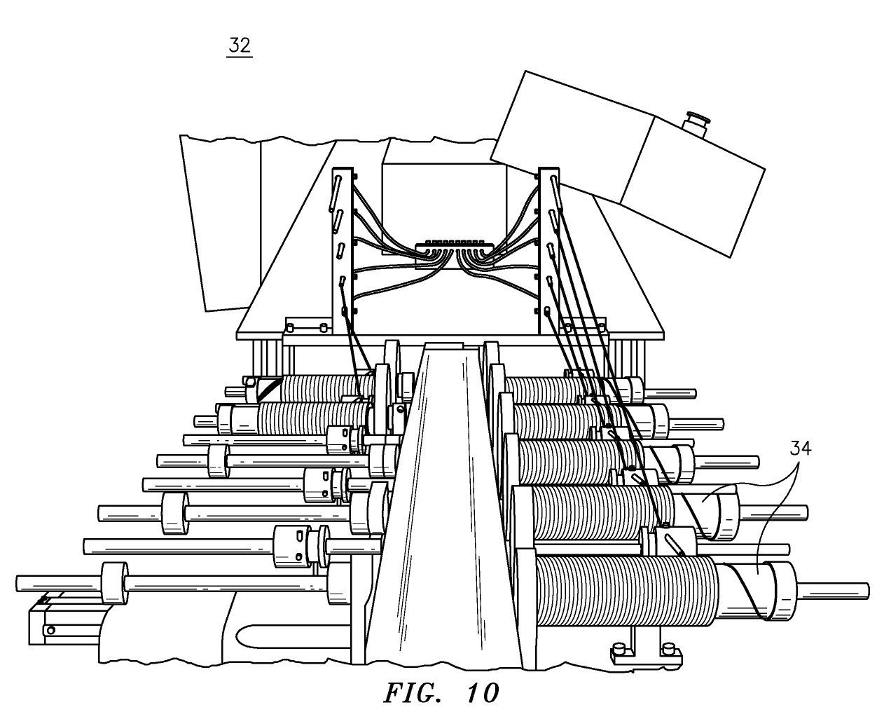

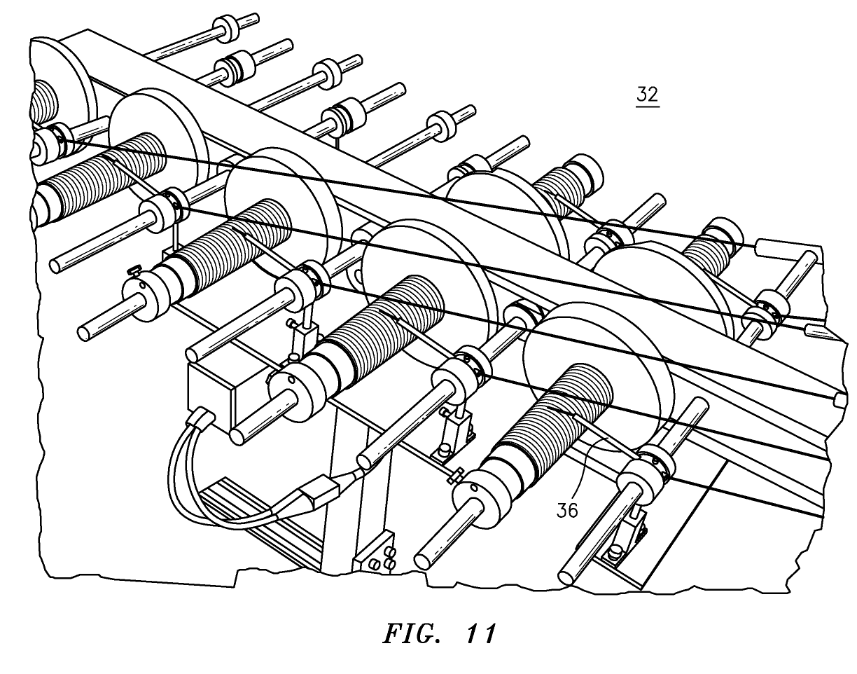

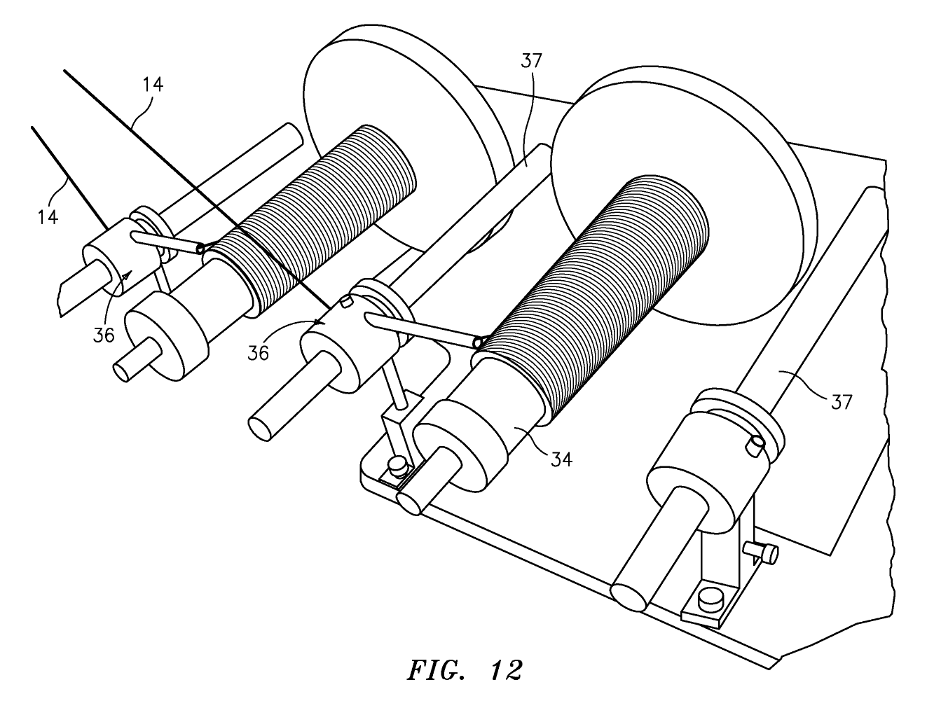

Upon exiting heating unit 28, fibers 14 are guided by conduits 31, shown in FIG. 9, to a winder assembly 32 more closely shown in FIGS. 10 and 11 Winder assembly 32 may be positioned at an angle to assist in the alignment of fibers 14 and minimize variances in the tension in each line. Brackets 33 and 35 may be used to position conduits 31 adjacent heating unit 28 and guide fibers 14 to winder assembly 32. Winder assembly 32 contains a series of spools 34 for winding the coated fibers thereon. Winder guides 36, more closely shown in FIG. 12, guide fibers 14 onto spools 34. Winder guides 36 move back and forth along a bar 37 depositing fiber 14 onto spool 34. Fibers 14 are pulled through the system by rotation of spools 34, which are controlled by a motor 38. Motor 38 may be a servo motor. Motor 38 can provide greater or lesser torque for pulling fibers 14 depending on how much force is needed to maintain fibers 14 in tension. The torque may be modified by varying the gear ratio of the motor. One example of providing a greater amount of torque is to provide a gear ratio of 4:1. This will generate a greater amount of torque which will improve the pull of fibers 14 by generating a smoother pull and assist in controlling a consistent metering of fibers 14 through the cycle. A motor 40 moves winder guides 36 back and forth along the perimeter of spools 34 to guide fibers 14 onto spools 34 in a consistent and even pattern.

In addition to tension bars 26 and 29 and in order to minimize line slippage and add additional tension to fibers 14, tension devices 42 may be positioned in the system. One example of placement of tension devices 42 is proximate sensors 18. In this way, tension is maintained at both ends of the line. The tension device may include a series of stainless steel slip washers that keep a very minimal amount of tension proximate to the sensors to prevent slippage of the fibers.

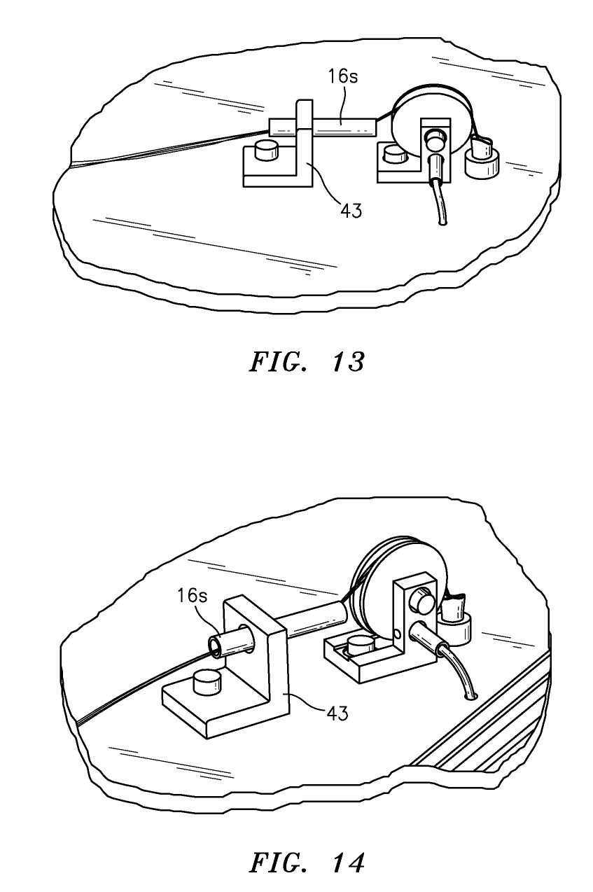

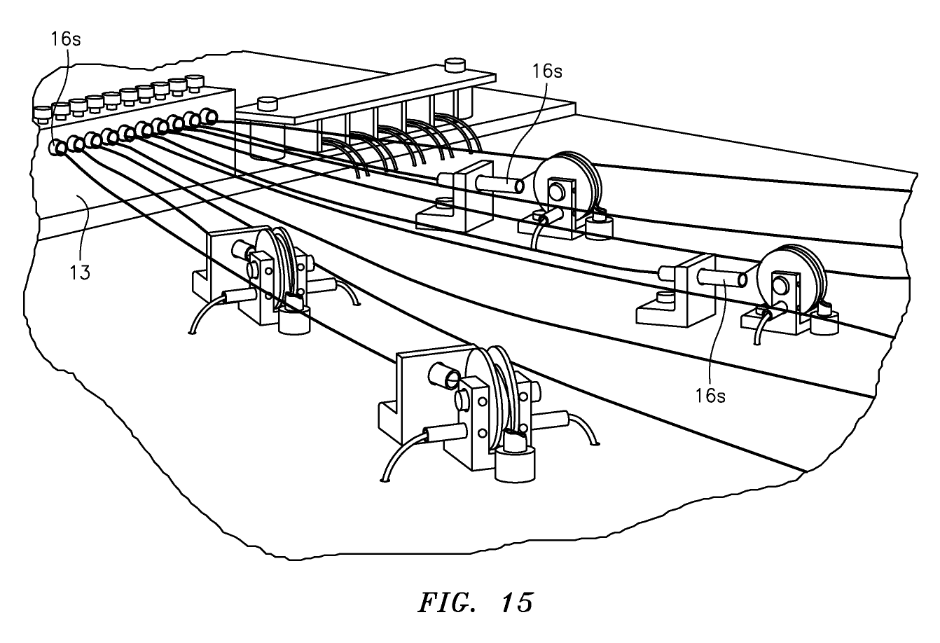

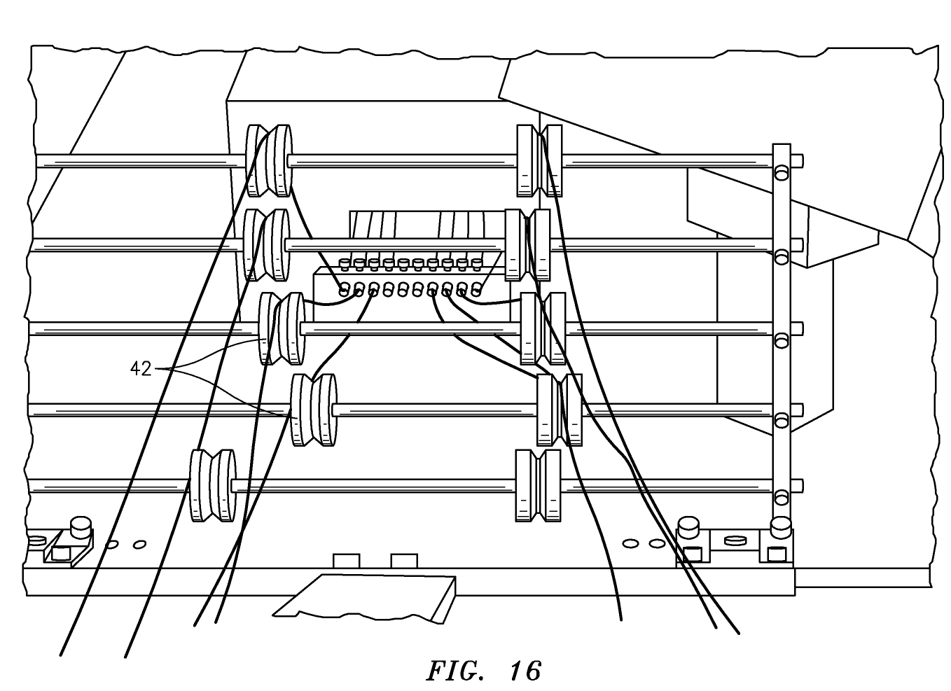

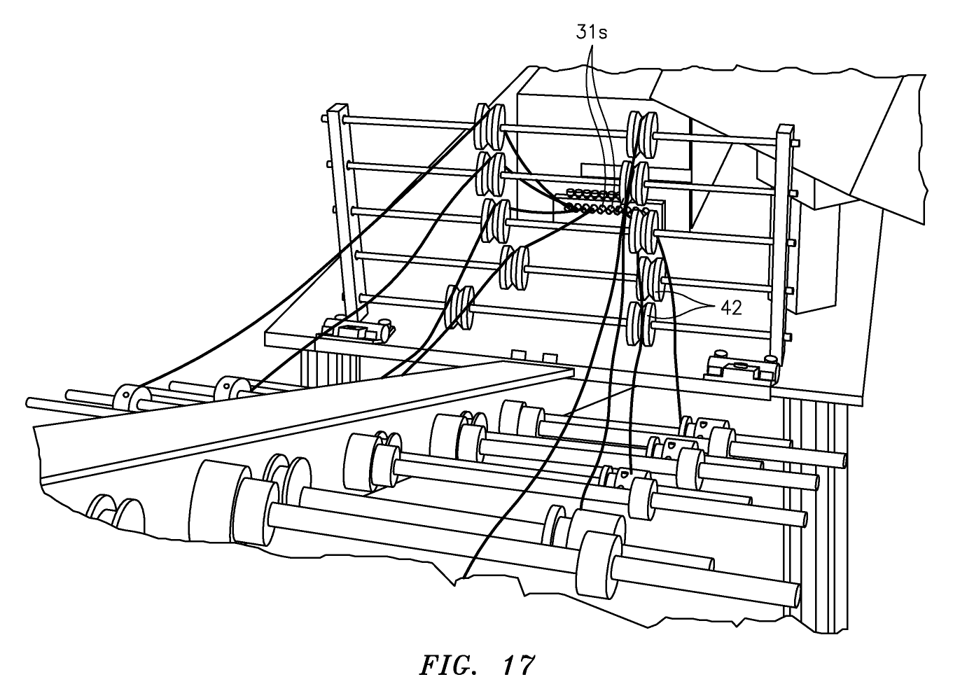

Alternatively, conduits 16s, which are used to guide entering fibers, may be shortened as shown in FIGS. 13, 14 and 15. Compared to FIG. 1, which shows the conduits 16 extending all the way to bracket 13, the conduits 16s are positioned proximate bobbin 21 and extend a short distance through bracket 43 and appear again in bracket 13. Moreover, after the fibers exit heating unit 28, they may be directed onto spools 42 shown in FIGS. 16 and 17 from shortened conduits 31s. If spools 42 are used, the conduits 31 are shortened to a length 31s to provide for spools 42. By shortening conduits 16 and 31, and adding spools 42 the tension or stress in the fibers may be lessoned.

The resulting fibers can be used in dental composites and dental restorations including but not limited to fillings, orthodontic retainers, orthodontic wires, bridges, space maintainers, tooth replacement appliances, dentures, crowns, posts, jackets, inlays, onlays, facings, veneers, facets, implants, abutments, cements, bonding agents and splints, to provide optimal handling properties, good wear resistance and high strength.

As will be appreciated, the present invention provides an automated system for applying a coating to fibers.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A system for coating fibers comprising:
a plurality of inlet conduits positioned downstream from a source of fibers, each inlet conduit configured to receive a corresponding fiber;
a reservoir positioned downstream from the inlet conduits for holding a coating solution to be applied to fibers passing through the reservoir from the inlet conduits;
a dryer positioned downstream from the reservoir for drying coated fibers exiting the reservoir;
a plurality of outlet conduits positioned downstream from the dryer, each outlet conduit configured to receive a corresponding fiber;
a winding assembly positioned downstream from the outlet conduits for individually winding fibers exiting from the plurality of outlet conduits;
a sensing device disposed between the source of fibers and the winding assembly for monitoring fiber conditions including fiber speed and fiber breakage; and
a control unit operatively associated with the sensing device, winding assembly and dryer.

2. The system of claim 1 further comprising a computer or programmable logic controller to start and stop the operation of the system and for providing a read-out of the system parameters.

3. The system of claim 1 wherein the sensing device comprises a plurality of sensors.

4. The system of claim 1 wherein the sensing device comprises a proximity switch, a limit switch, a hall-effect switch, an electro-mechanical switch, a motion switch, a magnetic sensor, thermocouple sensor or an optical sensor.

5. The system of claim 1 wherein the sensing device comprises a plurality of sensors positioned proximate the plurality of inlet conduits.

6. The system of claim 1 further comprising a series of reels positioned upstream from the plurality of inlet conduits upon which the fibers are positioned, whereby the reels rotate as the fibers are pulled through the system.

7. The system of claim 6 wherein the reels comprise an opening, which opening is detected by the sensing device as the reels rotate.

8. The system of claim 1 wherein the winder assembly comprises:
a plurality of finishing spools for winding the fibers thereon; and
a plurality of winder guides for guiding the fibers to the finishing spools.

9. The system of claim 8 wherein the winder guides are positioned on a bar and whereby the winder guides move back and forth to deposit the fibers on the finishing spools in a consistent pattern.

10. The system of claim 9 wherein the finishing spools rotate and pull the fibers through the system.

11. The system of claim 9 wherein the winder guides are positioned on a bar and connected to a first motor for movement along the bar.

12. The system of claim 10 wherein the finishing spools are connected to a second motor which rotates the finishing spools, whereby the fibers are pulled onto the rotating finishing spools.

13. The system of claim 1 wherein the reservoir and the dryer each comprise a plurality of tension rods for maintaining the fibers in tension.

14. The system of claim 13 wherein the tension rods comprise a series of grooves for maintaining alignment of the fibers.

15. The system of claim 1 wherein the reservoir is recessed in a table for maintaining fiber alignment.

16. The system of claim 1 wherein control unit is connected to a computer.

17. The system of claim 11 wherein the speed at which the fibers are passed through the system is from about 20 to about 100 inches/minute.

18. The system of claim 1 wherein the control unit controls the speed of the fibers and the temperature of the dryer.

19. The system of claim 18 wherein the temperature of the dryer is maintained in the range of about 100 to about 200° F.

20. The system of claim 1 wherein the coating solution comprises a silane solution.

21. The system of claim 20 wherein the silane solution comprises gamma-methacryloxypropyltrimethoxysilane.

22. The system of claim 1 wherein the fibers are provided on a plurality of starting spools.

23. The system of claim 1 further comprising a plurality of spools positioned downstream from the outlet conduits and positioned upstream from the winding assembly.

24. The system of claim 1 further comprising a plurality of tension devices positioned proximate the inlet conduits.

25. A process for coating fibers comprising:
passing a plurality of fibers through a plurality of inlet conduits, each inlet conduit configured to receive a corresponding fiber;
passing the fibers into a reservoir having a coating solution therein, whereby the fibers are coated with a coating solution;
passing the coated fibers through a dryer whereby the coating solution is dried;
passing the fibers through a plurality of outlet conduits for directing the fibers onto loading spools; and
winding the fibers onto the finishing spools.

26. The process of claim 25 whereby the fibers are provided on a plurality of starting spools and the fibers are unwound from the starting spools as the fibers are passed through the inlet conduits.

27. The process of claim 25 further comprising passing the fibers over a sensing device for sensing speed of the fibers and breakage of any one of the fibers.

28. The process of claim 25 whereby the process is terminated when the sensing device senses breakage of a fiber.

29. The process of claim 25 whereby the reservoir contains a first set of tension bars for maintaining the fibers in tension throughout the process.

30. The process of claim 25 whereby the dryer contains a second set of tension bars for maintaining the fibers in tension throughout the process.

31. The process of claim 25 whereby the process is controlled by a control unit.

32. The process of claim 25 further comprising maintaining the fibers in tension by placement of tension devices proximate each inlet conduit.
